(19) United States
(12) Patent Application Publication
(10) Pub. No.: US 2026/0081989 A1
(43) Pub. Date: Mar. 19, 2026

(54) RECOVERY MODE FOR A MOBILE DEVICE

(71) Applicant: Motorola Mobility LLC, Chicago, IL (US)

(72) Inventors: Ranjeet Gupta, Aurora, IL (US); Manju Mani, Bangalore (IN)

(73) Assignee: Motorola Mobility LLC, Chicago, IL (US)

(21) Appl. No.: 18/888,872

(22) Filed: Sep. 18, 2024

(51) Int. Cl. H04M 1/72454; H04W 4/029

(52) U.S. Cl. CPC H04M 1/72454; H04W 4/029

(57) ABSTRACT

Techniques for recovery mode for a mobile device are described and are implementable to enable locations of mobile devices to be tracked, such when a mobile device is stolen. For instance, an indication is received of a full device reset of a mobile device and in response to the indication of the full device reset, a key query is presented requesting a recovery key for the mobile device. A recovery mode is executed in response to an incorrect response to the key query, the recovery mode including causing the mobile device to obtain location data for a location of the mobile device and transmit the location data using user contact information stored on the mobile device.

### BACKGROUND

The use of mobile devices (e.g., mobile phones) has become commonplace across the world. For instance, users can perform a wide variety of different tasks using a mobile device, such as communication, productivity tasks, entertainment, etc. However, a user's mobile device may be obtained by a malicious party, such as by force as part of a holdup scenario. Further, the malicious party may sell the stolen mobile device, such as in an underground market.

### BRIEF DESCRIPTION OF THE DRAWINGS

Aspects of recovery mode for a mobile device are described with reference to the following Figures. The same numbers may be used throughout to reference similar features and components that are shown in the Figures. Further, identical numbers followed by different letters reference different instances of features and components described herein.

FIG. 1 illustrates an example environment in which aspects of recovery mode for a mobile device can be implemented.

FIG. 2 illustrates a signaling diagram in accordance with aspects of the present disclosure.

FIG. 3 depicts an example scenario in accordance with aspects of the present disclosure.

FIG. 4 depicts an example scenario in accordance with aspects of the present disclosure.

FIG. 5 depicts an example scenario in accordance with aspects of the present disclosure.

FIG. 6 depicts an example scenario in accordance with aspects of the present disclosure.

FIG. 7 illustrates a flow chart depicting an example method for recovery mode for a mobile device in accordance with one or more implementations.

FIG. 8 illustrates a flow chart depicting an example method for recovery mode for a mobile device in accordance with one or more implementations.

FIG. 9 illustrates a flow chart depicting an example method for recovery mode for a mobile device in accordance with one or more implementations.

FIG. 10 illustrates various components of an example device in which aspects of recovery mode for a mobile device can be implemented.

### DETAILED DESCRIPTION

Techniques for recovery mode for a mobile device are described and are implementable to enable a location of a mobile device to be tracked, such as after the mobile device is stolen. For instance, when a recovery mode is active, location data can be transmitted by the mobile device and the location data can be obtained by other devices to estimate a location of the stolen mobile device.

For example, consider a scenario in which a user in possession of a mobile phone is approached by a malicious party who demands the mobile phone, e.g., at gunpoint. The user hands over the mobile phone to the malicious party who then sells the device, such as in an illegal underground market. In a typical scenario the user would have no recourse and the phone would be lost.

However, in such a scenario, techniques described herein can be employed to track a location of the mobile phone and potentially regain possession of the mobile phone. For instance, after obtaining possession of the mobile phone, the malicious party may wish to reset the phone such that a party that purchases the mobile phone can reconfigure the mobile phone for their own purpose. Thus, the malicious party may perform a full device reset (FDR) (e.g., a factory reset) to delete the legitimate user's information such that new user information can be used to configure the mobile phone.

According to implementations described herein, in response to the FDR, the stolen mobile phone can activate a recovery mode. For instance, the original, legitimate owner of the mobile phone can configure a recovery profile on the mobile phone, such as when the original owner initially purchases and powers on the mobile phone. The recovery profile can include various information such as user contact information and a recovery key. Thus, when a FDR is performed on the stolen phone and the recovery mode is activated, a key query can be presented requesting entry of the recovery key.

When a correct recovery key is not provided after the FDR, the recovery mode can cause location information for the mobile phone to be transmitted using contact information from the recovery profile. Thus, the original user and/or a recovery service can receive notifications of locations of the stolen mobile phone, such as at different devices accessible to the original user. According to implementations, after initial configuration by the original user, the recovery profile is maintained in a tamper-resistant read-only permission state, such as by a kernel process of the mobile phone. Thus, location information for the mobile phone can be obtained by different parties and used to notify authorities of the location of the mobile device and potentially regain legal possession of the mobile device.

Accordingly, techniques for recovery mode for a mobile device can be implemented to track locations of mobile devices, such as in scenarios where possession of mobile devices is illegally obtained.

While features and concepts of recovery mode for a mobile device can be implemented in any number of environments and/or configurations, aspects of the described techniques are described in the context of the following example systems, devices, and methods. Further, the systems, devices, and methods described herein are interchangeable in various ways to provide for a wide variety of implementations and operational scenarios.

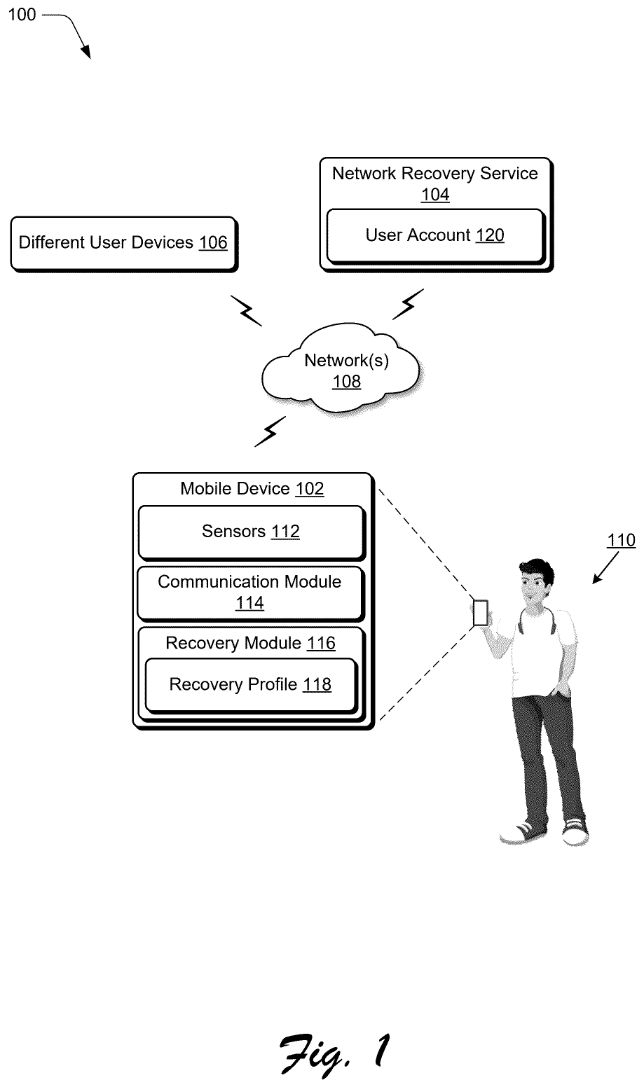

FIG. 1 illustrates an example environment 100 in which aspects of recovery mode for a mobile device can be implemented. The environment 100 includes a mobile device 102, a network recovery service 104, different user devices 106, and one or more network(s) 108. The mobile device 102 can be implemented in different ways, such as a mobile phone, a tablet device, a wearable device, an extended reality (e.g., virtual reality, mixed reality) device, etc. The mobile device 102 represents a device that is registered to (e.g., owned by) a user 110 and the different user devices 106 represent different devices that are accessible to the user 110, such as a different mobile device, a laptop computer, a desktop computer, etc. The network recovery service 104 represents a network-based service that can communicate with the mobile device 102 and the different user devices 106 (e.g., via the network(s) 108) to perform and/or assist with various operations pertaining to recovery mode for a mobile device described herein.

The mobile device 102 includes functionality that is operable in association with techniques for recovery mode for a mobile device described herein including sensors 112, a communication module 114, and a recovery module 116. The sensors 112 are representative of functionality to detect various physical and/or logical phenomena in relation to the mobile device 102, such as device location, position, motion, light, image detection and recognition, time and date, touch detection, sound (e.g., voice), temperature, and so forth. Examples of the sensors 112 include hardware and/or logical sensors such as an accelerometer, a gyroscope, a camera, a microphone, a clock, biometric sensors, touch input sensors, position sensors, environmental sensors (e.g., for temperature, pressure, humidity, and so on), geographical location information sensors (e.g., Global Positioning System (GPS) functionality), and so forth. The sensors 112, however, can include a variety of other sensor types in accordance with the implementations discussed herein.

The communication module 114 represents functionality for enabling various types of wireless and wired communication of the mobile device 102. The communication module 114, for instance, enables wireless connectivity and communication of the mobile device, such as wireless cellular, wide area network (WAN), wireless local area network (WLAN), etc. The recovery module 116 represents functionality for performing various aspects of recovery mode for a mobile device described herein. For instance, the recovery module 116 includes a recovery profile 118 that can be utilized to store recovery information for the user 110 of the mobile device 102, such as user email information, user phone number(s), an authentication key, etc. As further detailed below the recovery profile 118 can be configured at initial device startup (e.g., as part of an out of box (OOB) experience) and/or as part of a full device reset (FDR). As used herein, a FDR may represent a factory reset of the mobile device 102.

In implementations and as described throughout this disclosure, when a FDR occurs, the recovery module 116 can gather information about the mobile device 102 such as device location, and cause the information to be communicated (e.g., transmitted) to other entities and locations. For instance, information about the mobile device 102 can be transmitted by the mobile device 102 for access via the different user devices 106.

The network recovery service 104 is representative of a network-based service that can assist in performing and/or assisting with various aspects of recovery mode for a mobile device described herein. For instance, the network recovery service 104 includes a user account 120 associated with the mobile device 102 and/or the user 110. In implementations the user account 120 can be associated with the recovery profile 118 and can include at least some information from the recovery profile 118.

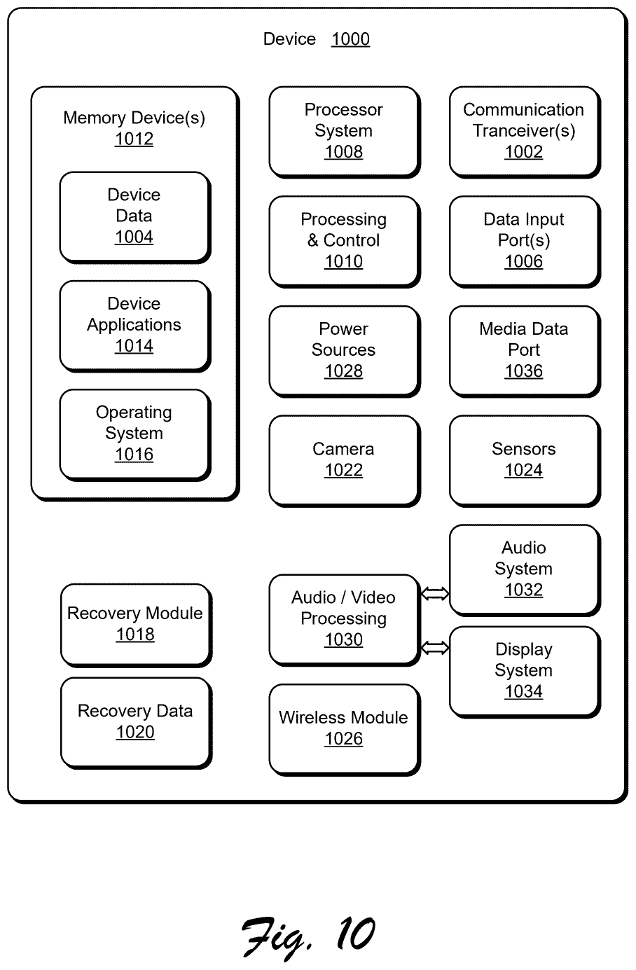

The mobile device 102, the different user devices 106, and the network recovery service 104 can be implemented in various ways and include various functionality, examples of which are discussed below with reference to the example device 1000 of FIG. 10. Further, the network(s) 108 can represent a combination of wired and wireless networks via which the mobile device 102, the different user devices 106, and the network recovery service 104 can participate in various types of communication, such as wired and/or wireless data communication.

Having discussed an example environment in which the disclosed techniques can be performed, consider now some example scenarios and implementation details for implementing the disclosed techniques.

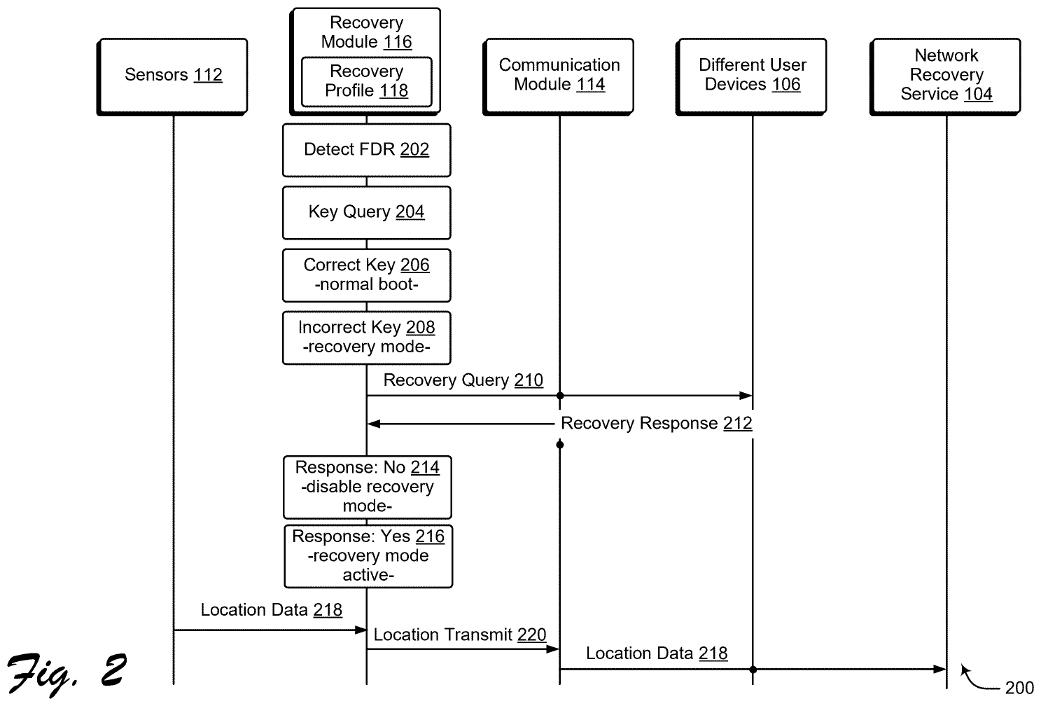

FIG. 2 illustrates a signaling diagram 200 in accordance with aspects of the present disclosure. In the signaling diagram 200, at 202 the recovery module 116 detects that a FDR of the mobile device 102 occurs. In at least some scenarios the FDR can occur after an unauthorized access to the mobile device 102, e.g., after the mobile device 102 is stolen from the user 110. In response to the FDR, the recovery module 116 causes a key query 204 to be presented via the mobile device 102. The key query 204, for instance, requests that an authentication and/or authorization key (a “recovery key”) be entered to the mobile device 102. If a correct key is provided at 206, the mobile device 102 boots and operates as normal.

Further to signaling diagram 200, if at 208 an incorrect key is provided (and/or no key is provided), the recovery module 116 activates a recovery mode. In response to activation of the recovery mode, the recovery module 116 communicates a recovery mode query 210 to a different user device 106, such as via the communication module 114. The recovery mode query 210, for instance, queries whether the recovery mode is to remain active to track a location of the mobile device 102. The recovery module 116 then receives a recovery mode response 212 indicating whether the recovery mode is to remain active on the mobile device 102, e.g., a “yes” or “no” response.

If the recovery mode response 212 indicates a negative response (e.g., “no”), at 214 the recovery mode is disabled on the mobile device 102. For instance, location information for the mobile device 102 is not gathered and transmitted. If the recovery mode response 212 indicates a positive response (e.g., “yes”), at 216 the recovery mode remains active on the mobile device 102 such that location information for the mobile device 102 is gathered and transmitted. For instance, in the recovery mode the recovery module 116 obtains location data 218 from the sensors 112 and communicates a location transmit instruction 220 to the communication module 114. The location data 218, for instance, indicates a location of the mobile device 102, such as geographic location, network location, physical address, etc. The location transmit instruction 220, for example, includes the location data 218 as well as contact information from the recovery profile 118, such an email address, phone number (e.g., alternate phone number from the mobile device 102), and/or other type of contact information.

Accordingly, the communication module 114 utilizes the contact information to transmit the location data 218 to the different user device 106 and/or the network recovery service 104. Thus, the user 110 and/or other party can receive a notification of the location of the mobile device 102, such as to attempt to recover possession of the mobile device 102. In implementations the location data 218 can be periodically obtained and transmitted by the mobile device 102, such as track movement and different locations of the mobile device 102 over time.

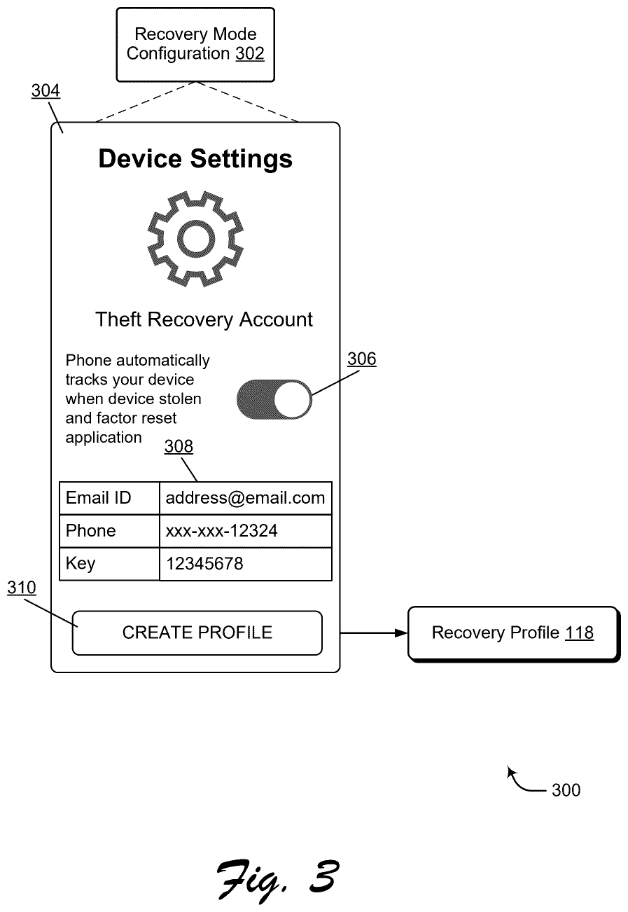

FIG. 3 depicts an example scenario 300 in accordance with aspects of the present disclosure. In the scenario 300 a recovery mode configuration 302 is performed (e.g., by the recovery module 116) to generate a recovery profile 118. As part of the recovery mode configuration 302 a configuration graphical user interface (GUI) 304 is presented that enables user interaction. For instance, the configuration GUI 304 includes a control 306 that is selectable to enable and disable a recovery mode for the mobile device 102.

The configuration GUI 304 further includes profile information fields 308 that can receive user input to specify different information for the recovery profile 118. For instance, the profile information fields 308 can be populated with user contact information, e.g., email address, phone number, and/or other types of contact information. Further, the profile information fields 308 can be populated with a recovery key (“Key”) associated with a recovery mode of the mobile device 102. The recovery key, for example, can be used to enable, disable, configure, and reconfigure a recovery mode and/or a recovery profile 118.

Further to the scenario 300, recovery information is populated to the profile information fields 308 and a create control 310 is selected to cause the recovery profile 118 to be generated based at least in part on the information in the profile information fields 308. As mentioned above, the recovery profile 118 can be managed by a kernel (e.g., operating system kernel) of the mobile device 102. For instance, the kernel can control access to the recovery profile 118 and after initial creation of the recovery profile (e.g., in conjunction with a factory power on such as OOB experience), the kernel can maintain the recovery profile 118 in a read-only state such that other functionality of the mobile device 102 cannot access the recovery profile 118 and the recovery profile 118 cannot be edited and/or removed without access to the recovery key.

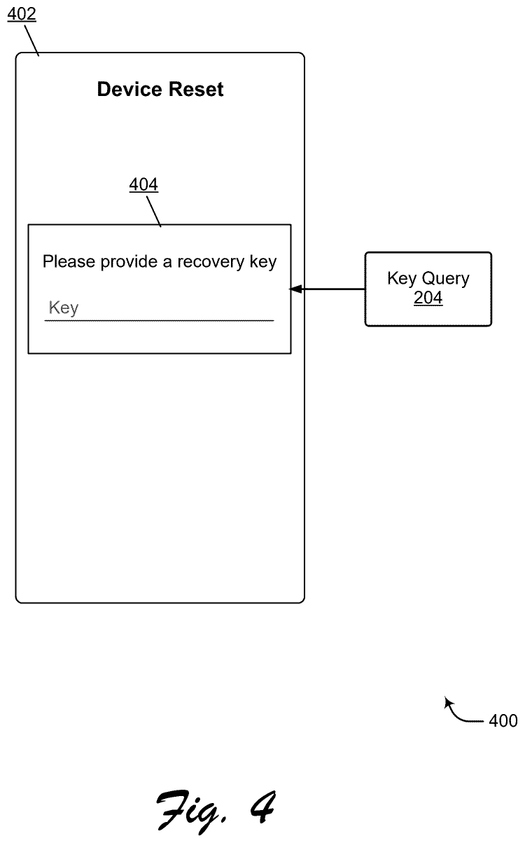

FIG. 4 depicts an example scenario 400 in accordance with aspects of the present disclosure. The scenario 400 includes a device reset GUI 402 that is presented after a FDR. The device reset GUI 402 include a key query field 404 that is presented as part of a key query 204. Entering a correct recovery key into the key query field 404 can prevent a recovery mode from being activated and the mobile device 102 to boot into a normal operating mode. However, entering an incorrect recovery key into the key query field 404 can cause a recovery mode to be activated, e.g., after a threshold number of incorrect key entry attempts.

For instance, in a scenario where a malicious party obtains unauthorized access to the mobile device 102 and performs a FDR, the key query field 404 can be presented. After a failure to provide a correct recovery key into the key query field 404, a recovery mode can be activated on the mobile device 102.

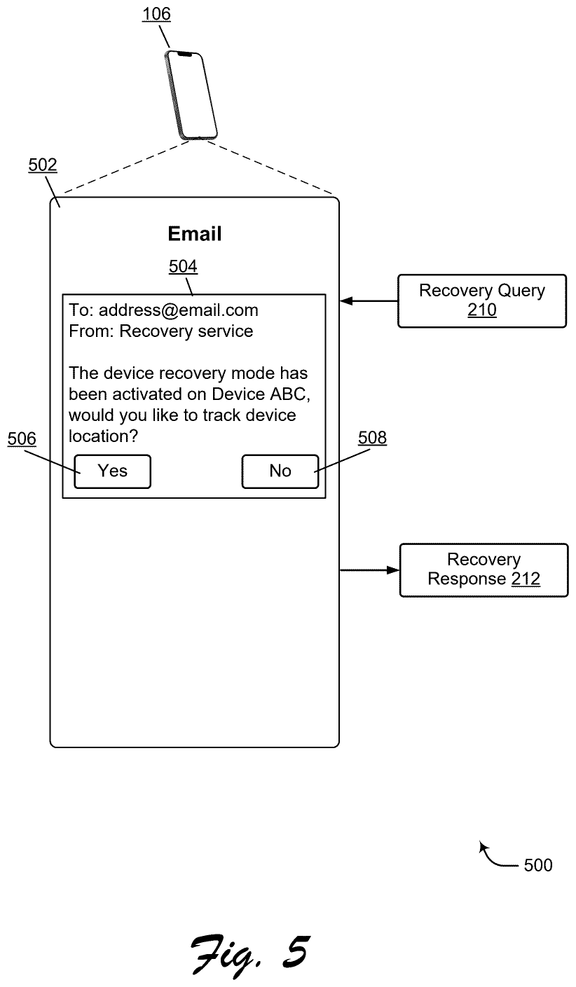

FIG. 5 depicts an example scenario 500 in accordance with aspects of the present disclosure. The scenario 500 includes a communication GUI 502 that can be presented on a different user device 106. The communication GUI 502, for instance, can be presented by a communication application, such as email application, a text application, and/or other communication type application. In this particular example the communication GUI 502 is populated with email content.

As part of a recovery mode query 210 a query email 504 is presented within the communication GUI 502. The query email 504, for instance, is communicated by the recovery module 116 of the mobile device 102 to the different user device 106 and based on contact information included in the recovery profile 118. The query email indicates that a recovery mode has been activated on the mobile device 102 (e.g., device identifier “Device ABC”) and queries whether a device location for the mobile device 102 is to be tracked. The query email 504 includes a confirm control 506 and a decline control 508. Selection of the confirm control 506 or the decline control 508 can cause a recovery mode response 212 to be generated and transmitted to the mobile device 102. For instance, selection of the confirm control 506 generates the recovery mode response 212 to confirm that the recovery mode is to remain active and that location information for the mobile device 102 is to be transmitted, such as to the different user device 106. Selection of the decline control 508 generates the recovery mode response 212 to indicate that the recovery mode is to be deactivated and that location information for the mobile device 102 is not to be transmitted.

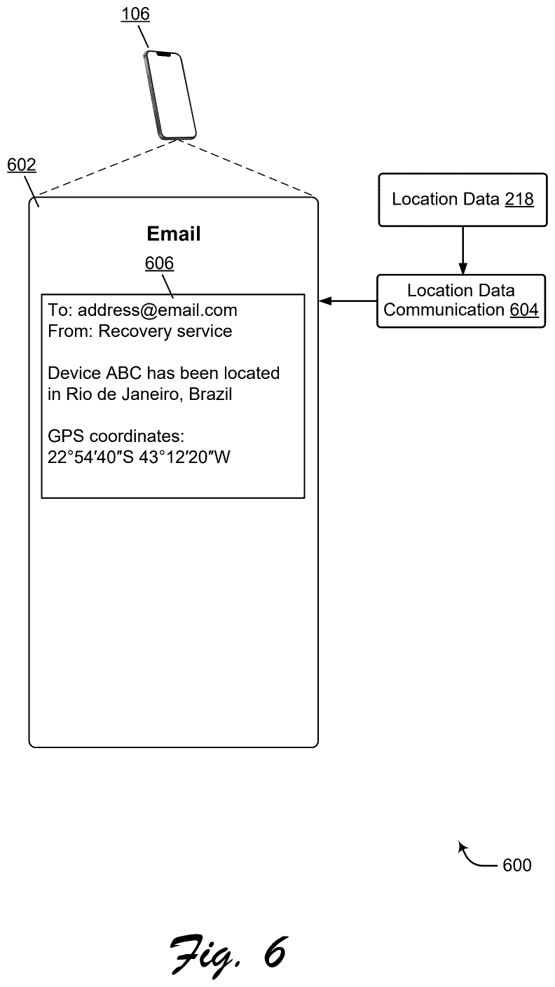

FIG. 6 depicts an example scenario 600 in accordance with aspects of the present disclosure. The scenario 600 includes a communication GUI 602 that can be presented on a different user device 106. The communication GUI 602, for instance, can represent an instance of the communication GUI 502 or a different communication GUI. In response to activation of the recovery mode on the mobile device 102, the mobile device 102 transmits location data 218 which is received at the different user device 106 as a location data communication 604. The location data communication 604 is communicated to the different user device 106 using contact information from the recovery profile 118 and can include location information as well as other information types. For instance, the location data 218 transmitted by the mobile device 102 can be modified and/or expanded to include further explanatory information.

Accordingly, a location email 606 is presented in the communication GUI 602 that include location information from the location data communication 604. The location email 606, for instance, can include location information such as geographic coordinates, geographical locations (e.g., countries, cities, placenames, etc.), street addresses, etc. The location email 606, for example, identifies a most recent location at which the mobile device 102 transmitted location data. As referenced above, for instance, in the recovery mode the mobile device 102 can periodically transmit location data and thus location data communications 604 can be periodically transmitted to contact information included in the recovery profile 118.

While the scenarios 500, 600 are discussed with reference to a same communication modality (e.g., email), it is to be appreciated that a recovery mode query 210 and a location data communication 604 may be communicated via different respective communication modalities. Further, a recovery mode query 210 and a location data communication 604 can be communicated to different respective instances of different user devices 106 and/or received by different respective instances of different user devices 106.

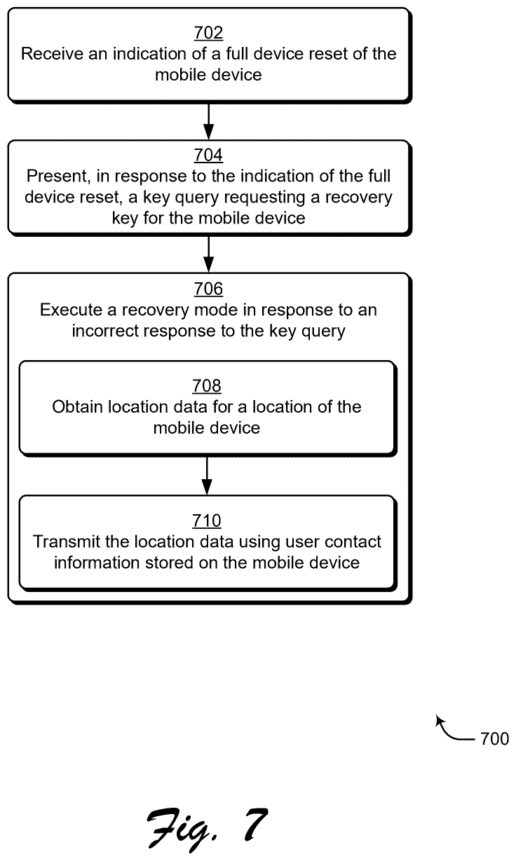

FIG. 7 illustrates a flow chart depicting an example method 700 for recovery mode for a mobile device in accordance with one or more implementations. Operations of the method 700, for instance, may be performed in the context of the environment 100, such as by the mobile device 102 and/or the network recovery service 104.

At 702 an indication is received of a full device reset of the mobile device. The recovery module 116, for instance, receives an indication of a FDR (e.g., a factory reset) of the mobile device 102, such as from an operating system of the mobile device 102. At 704, in response to the indication of the full device reset, a key query is presented requesting a recovery key for the mobile device. For example, the recovery module 116 causes a key query to be output by the mobile device 102 requesting entry of a recovery key.

At 706 a recovery mode is executed in response to an incorrect response to the key query. For instance, as part of the recovery mode, at 708 location data is obtained for a location of the mobile device. The recovery module 116, for example, obtains location-based sensor data from the sensors 112. As further part of the recovery mode, at 710 the location data is transmitted using user contact information stored on the mobile device.

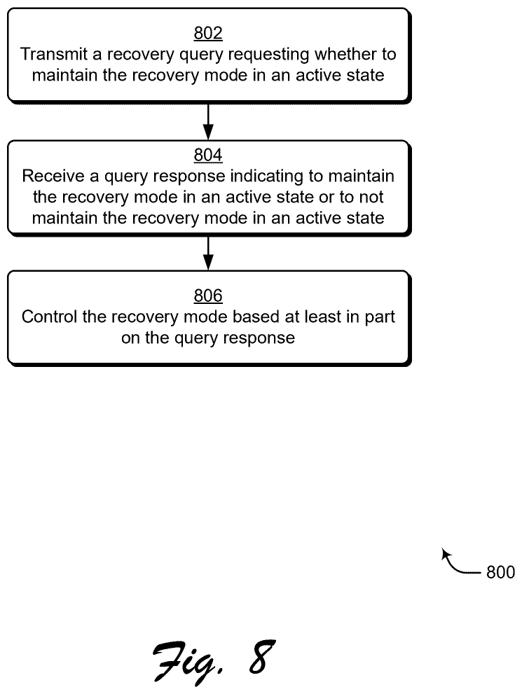

FIG. 8 illustrates a flow chart depicting an example method 800 for recovery mode for a mobile device in accordance with one or more implementations. Operations of the method 800, for instance, may be performed in the context of the environment 100, such as by the mobile device 102 and/or the network recovery service 104. Further, the method 800 may be performed in conjunction with the method 700.

At 802 a recovery query is transmitted requesting whether to maintain the recovery mode in an active state. The recovery module 116, for example, cause a recovery query to be transmitted using contact information associated with a recovery profile 118. In at least one implementation the recovery query is transmitted to a different user device 106.

At 804 a query response is received indicating to maintain the recovery mode in an active state or to not maintain the recovery mode in an active state. At 806 the recovery mode is controlled based at least in part on the query response. For instance, based on a negative response to the recovery query, the recovery module 116 can disable a recovery mode on the mobile device 102. Further, based on a positive response to the recovery query, the recovery module 116 can maintain the recovery mode in an active state on the mobile device 102.

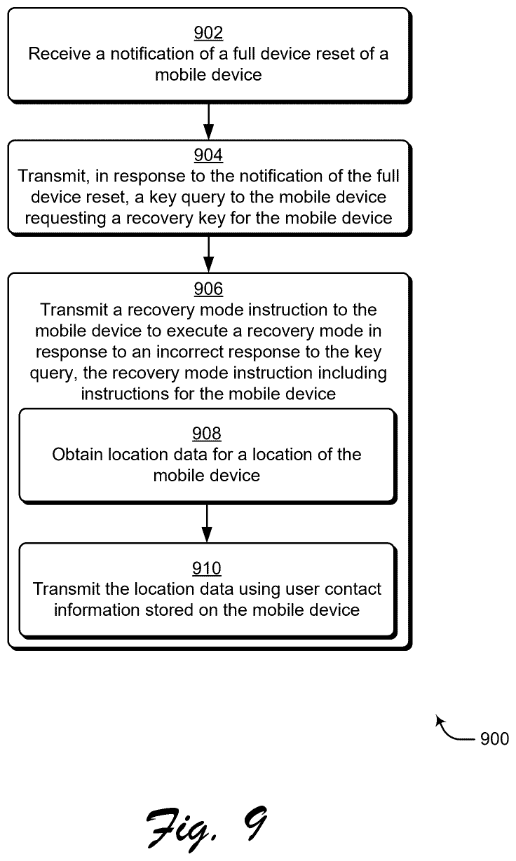

FIG. 9 illustrates a flow chart depicting an example method 900 for recovery mode for a mobile device in accordance with one or more implementations. Operations of the method 900, for instance, may be performed in the context of the environment 100, such as by the network recovery service 104. Further, the method 900 may be performed in conjunction with the methods 700, 800.

At 902 a notification is received of a full device reset of a mobile device. The network recovery service 104, for example, receives a notification from the mobile device 102 that the mobile device 102 has undergone a FDR, e.g., a factory reset. At 904, in response to the notification of the full device reset, a key query is transmitted to the mobile device requesting a recovery key for the mobile device. The network recovery service 104, for example, transmits a key query to the mobile device 102.

At 906 a recovery mode instruction is transmitted to the mobile device to execute a recovery mode in response to an incorrect response to the key query, the recovery mode instruction including instructions for the mobile device. For instance, the instructions for the mobile device include at 908 to obtain location data for a location of the mobile device. Further, the instructions for the mobile device include at 910 to transmit the location data using user contact information stored on the mobile device. According to implementations, the instructions from the network recovery service 104 can be received and executed, at least in part, by the recovery module 116.

The example methods described above may be performed in various ways, such as for implementing different aspects of the systems and scenarios described herein. Generally, any services, components, modules, methods, and/or operations described herein can be implemented using software, firmware, hardware (e.g., fixed logic circuitry), manual processing, or any combination thereof. Some operations of the example methods may be described in the general context of executable instructions stored on computer-readable storage memory that is local and/or remote to a computer processing system, and implementations can include software applications, programs, functions, and the like. Alternatively or in addition, any of the functionality described herein can be performed, at least in part, by one or more hardware logic components, such as, and without limitation, Field-programmable Gate Arrays (FPGAs), Application-specific Integrated Circuits (ASICs), Application-specific Standard Products (ASSPs), System-on-a-chip systems (SoCs), Complex Programmable Logic Devices (CPLDs), and the like. The order in which the methods are described is not intended to be construed as a limitation, and any number or combination of the described method operations can be performed in any order to perform a method, or an alternate method.

FIG. 10 illustrates various components of an example device 1000 in which aspects of recovery mode for a mobile device can be implemented. The example device 1000 can be implemented as any of the devices described with reference to the previous FIGS. 1-9, such as any type of mobile device, mobile phone, mobile device, wearable device, tablet, computing, communication, entertainment, gaming, media playback, and/or other type of electronic device. For example, the mobile device 102, the network recovery service 104, and/or the different user devices 106 as shown and described with reference to FIGS. 1-9 may be implemented as the example device 1000.

The device 1000 includes communication transceivers 1002 that enable wired and/or wireless communication of device data 1004 with other devices. The device data 1004 can include one or more of device identifying data, device location data, wireless connectivity data, and wireless protocol data. Additionally, the device data 1004 can include any type of audio, video, and/or image data. Example communication transceivers 1002 include wireless personal area network (WPAN) radios compliant with various IEEE 802.15 (Bluetooth™) standards, wireless local area network (WLAN) radios compliant with any of the various IEEE 802.10 (Wi-Fi™) standards, wireless wide area network (WWAN) radios for cellular phone communication, wireless metropolitan area network (WMAN) radios compliant with various IEEE 802.16 (WiMAX™) standards, and wired local area network (LAN) Ethernet transceivers for network data communication.

The device 1000 may also include one or more data input ports 1006 via which any type of data, media content, and/or inputs can be received, such as user-selectable inputs to the device, messages, music, television content, recorded content, and any other type of audio, video, and/or image data received from any content and/or data source. The data input ports may include USB ports, coaxial cable ports, and other serial or parallel connectors (including internal connectors) for flash memory, DVDs, CDs, and the like. These data input ports may be used to couple the device to any type of components, peripherals, or accessories such as microphones and/or cameras.

The device 1000 includes a processing system 1008 of one or more processors (e.g., any of microprocessors, controllers, and the like) and/or a processor and memory system implemented as a system-on-chip (SoC) that processes computer-executable instructions. The processor system may be implemented at least partially in hardware, which can include components of an integrated circuit or on-chip system, an application-specific integrated circuit (ASIC), a field-programmable gate array (FPGA), a complex programmable logic device (CPLD), and other implementations in silicon and/or other hardware. Alternatively or in addition, the device can be implemented with any one or combination of software, hardware, firmware, or fixed logic circuitry that is implemented in connection with processing and control circuits, which are generally identified at 1010. The device 1000 may further include any type of a system bus or other data and command transfer system that couples the various components within the device. A system bus can include any one or combination of different bus structures and architectures, as well as control and data lines.

The device 1000 also includes computer-readable storage memory 1012 (e.g., memory devices) that enable data storage, such as data storage devices that can be accessed by a computing device, and that provide persistent storage of data and executable instructions (e.g., software applications, programs, functions, and the like). Examples of the computer-readable storage memory 1012 include volatile memory and non-volatile memory, fixed and removable media devices, and any suitable memory device or electronic data storage that maintains data for computing device access. The computer-readable storage memory can include various implementations of random access memory (RAM), read-only memory (ROM), flash memory, and other types of storage media in various memory device configurations. The device 1000 may also include a mass storage media device.

The computer-readable storage memory 1012 provides data storage mechanisms to store the device data 1004, other types of information and/or data, and various device applications 1014 (e.g., software applications). For example, an operating system 1016 can be maintained as software instructions with a memory device and executed by the processing system 1008. The device applications may also include a device manager, such as any form of a control application, software application, signal-processing and control module, code that is native to a particular device, a hardware abstraction layer for a particular device, and so on. Computer-readable storage memory 1012 represents media and/or devices that enable persistent and/or non-transitory storage of information in contrast to mere signal transmission, carrier waves, or signals per se. Computer-readable storage memory 1012 do not include signals per se or transitory signals.

In this example, the device 1000 includes a recovery module 1018 and recovery data 1020 that can implement aspects of recovery mode for a mobile device and may be implemented with hardware components and/or in software. For example, the recovery module 1018 can be implemented as the recovery module 116, described in detail above. In implementations, the recovery module 1018 may include independent processing, memory, and logic components as a computing and/or electronic device integrated with the device 1000. Further, the recovery data 1020 can include data usable as part of the described techniques, such as recovery profiles 118, location data, etc.

In this example, the example device 1000 also includes a camera 1022 and sensors 1024. The sensors 1024 can be implemented in various ways and are representative of functionality to detect various physical and/or logical phenomena in relation to the device 1000, such as motion, light, image detection and recognition, time and date, position, location, touch detection, sound, temperature, and so forth. Examples of the sensors 1024 include hardware and/or logical sensors such as an accelerometer, a gyroscope, a camera, a microphone, a clock, biometric sensors, touch input sensors, position sensors, environmental sensors (e.g., for temperature, pressure, humidity, and so on), geographical location information sensors (e.g., Global Positioning System (GPS) functionality), and so forth.

The device 1000 also includes a wireless module 1026, which is representative of functionality to perform various wireless communication tasks. The device 1000 can also include one or more power sources 1028, such as when the device is implemented as a mobile device. The power sources 1028 may include a charging and/or power system, and can be implemented as a flexible strip battery, a rechargeable battery, a charged super-capacitor, and/or any other type of active or passive power source.

The device 1000 also includes an audio and/or video processing system 1030 that generates audio data for an audio system 1032 and/or generates display data for a display system 1034. The audio system and/or the display system may include any devices that process, display, and/or otherwise render audio, video, display, and/or image data. Display data and audio signals can be communicated to an audio component and/or to a display component via an RF (radio frequency) link, S-video link, HDMI (high-definition multimedia interface), composite video link, component video link, DVI (digital video interface), analog audio connection, or other similar communication link, such as media data port 1036. In implementations, the audio system and/or the display system are integrated components of the example device. Alternatively, the audio system and/or the display system are external, peripheral components to the example device.

Although implementations of recovery mode for a mobile device have been described in language specific to features and/or methods, the subject of the appended claims is not necessarily limited to the specific features or methods described. Rather, the features and methods are disclosed as example implementations, and other equivalent features and methods are intended to be within the scope of the appended claims. Further, various different examples are described and it is to be appreciated that each described example can be implemented independently or in connection with one or more other described examples. Additional aspects of the techniques, features, and/or methods discussed herein relate to one or more of the following:

In some aspects, the techniques described herein relate to a mobile device including: at least one memory; and at least one processor coupled with the at least one memory and configured to cause the mobile device to: receive an indication of a full device reset of the mobile device; present, in response to the indication of the full device reset, a key query requesting a recovery key for the mobile device; and execute a recovery mode in response to an incorrect response to the key query, the recovery mode including causing the mobile device to: obtain location data for a location of the mobile device; and transmit the location data using user contact information stored on the mobile device.

In some aspects, the techniques described herein relate to a mobile device, wherein the at least one processor is configured to cause the mobile device to generate a recovery account for the mobile device, wherein the recovery account includes a correct key that corresponds to the key query.

In some aspects, the techniques described herein relate to a mobile device, wherein the recovery account further includes the user contact information.

In some aspects, the techniques described herein relate to a mobile device, wherein the recovery account and the recovery mode are managed, at least in part, by a kernel module of the mobile device.

In some aspects, the techniques described herein relate to a mobile device, wherein the recovery account is stored on the mobile device in a read-only permission state.

In some aspects, the techniques described herein relate to a mobile device, wherein the location data includes one or more of geographical location data or network location data.

In some aspects, the techniques described herein relate to a mobile device, wherein the user contact information includes one or more of an email associated with a registered user of the mobile device or a phone number associated with the registered user of the mobile device.

In some aspects, the techniques described herein relate to a mobile device, wherein the at least one processor is configured to cause the mobile device to boot into a normal operating state in response to a correct response to the key query such that the recovery mode is not executed.

In some aspects, the techniques described herein relate to a mobile device, wherein the at least one processor is configured to cause the mobile device to: transmit a recovery query requesting whether to maintain the recovery mode in an active state; receive a query response indicating to maintain the recovery mode in an active state or to not maintain the recovery mode in an active state; and control the recovery mode based at least in part on the query response.

In some aspects, the techniques described herein relate to a method performed by a mobile device, the method including: receiving an indication of a full device reset of the mobile device; presenting, in response to the indication of the full device reset, a key query requesting a recovery key for the mobile device; and executing a recovery mode in response to an incorrect response to the key query, the recovery mode including: obtaining location data for a location of the mobile device; and transmitting the location data using user contact information stored on the mobile device.

In some aspects, the techniques described herein relate to a method, further including generating a recovery account for the mobile device, wherein the recovery account includes a correct key that corresponds to the key query.

In some aspects, the techniques described herein relate to a method, wherein the recovery account further includes the user contact information.

In some aspects, the techniques described herein relate to a method, wherein the recovery account and the recovery mode are managed, at least in part, by a kernel module of the mobile device.

In some aspects, the techniques described herein relate to a method, wherein the recovery account is stored on the mobile device in a read-only permission state.

In some aspects, the techniques described herein relate to a method, wherein the user contact information includes one or more of an email associated with a registered user of the mobile device or a phone number associated with the registered user of the mobile device.

In some aspects, the techniques described herein relate to a method, further including booting into a normal operating state in response to a correct response to the key query such that the recovery mode is not executed.

In some aspects, the techniques described herein relate to a method, further including: receiving a recovery mode disable indication from a different device; and disabling execution of the recovery mode.

In some aspects, the techniques described herein relate to a system including: at least one memory; and at least one processor coupled to the at least one memory and configured to cause the system to: receive a notification of a full device reset of a mobile device; transmit, in response to the notification of the full device reset, a key query to the mobile device requesting a recovery key for the mobile device; and transmit a recovery mode instruction to the mobile device to execute a recovery mode in response to an incorrect response to the key query, the recovery mode instruction including instructions for the mobile device to: obtain location data for a location of the mobile device; and transmit the location data using user contact information stored on the mobile device.

In some aspects, the techniques described herein relate to a system, wherein the recovery mode instruction further includes an instruction to boot the mobile device into a normal operating state in response to a correct response to the key query such that the recovery mode is not executed.

In some aspects, the techniques described herein relate to a system, wherein the at least one processor is configured to cause the system to receive, from the mobile device, one or more location notifications indicating a location of the mobile device.

1. A mobile device comprising:
at least one memory; and
at least one processor coupled with the at least one memory and configured to cause the mobile device to:
receive an indication of a full device reset of the mobile device;
present, in response to the indication of the full device reset, a key query requesting a recovery key for the mobile device; and
execute a recovery mode in response to an incorrect response to the key query, the recovery mode including causing the mobile device to:
obtain location data for a location of the mobile device; and
transmit the location data using user contact information stored on the mobile device.

2. The mobile device of claim 1, wherein the at least one processor is configured to cause the mobile device to generate a recovery account for the mobile device, wherein the recovery account comprises a correct key that corresponds to the key query.

3. The mobile device of claim 2, wherein the recovery account further comprises the user contact information.

4. The mobile device of claim 2, wherein the recovery account and the recovery mode are managed, at least in part, by a kernel module of the mobile device.

5. The mobile device of claim 2, wherein the recovery account is stored on the mobile device in a read-only permission state.

6. The mobile device of claim 1, wherein the location data comprises one or more of geographical location data or network location data.

7. The mobile device of claim 1, wherein the user contact information comprises one or more of an email associated with a registered user of the mobile device or a phone number associated with the registered user of the mobile device.

8. The mobile device of claim 1, wherein the at least one processor is configured to cause the mobile device to boot into a normal operating state in response to a correct response to the key query such that the recovery mode is not executed.

9. The mobile device of claim 1, wherein the at least one processor is configured to cause the mobile device to:
transmit a recovery query requesting whether to maintain the recovery mode in an active state;
receive a query response indicating to maintain the recovery mode in an active state or to not maintain the recovery mode in an active state; and
control the recovery mode based at least in part on the query response.

10. A method performed by a mobile device, the method comprising:
receiving an indication of a full device reset of the mobile device;
presenting, in response to the indication of the full device reset, a key query requesting a recovery key for the mobile device; and
executing a recovery mode in response to an incorrect response to the key query, the recovery mode including:
obtaining location data for a location of the mobile device; and
transmitting the location data using user contact information stored on the mobile device.

11. The method of claim 10, further comprising generating a recovery account for the mobile device, wherein the recovery account comprises a correct key that corresponds to the key query.

12. The method of claim 11, wherein the recovery account further comprises the user contact information.

13. The method of claim 11, wherein the recovery account and the recovery mode are managed, at least in part, by a kernel module of the mobile device.

14. The method of claim 11, wherein the recovery account is stored on the mobile device in a read-only permission state.

15. The method of claim 10, wherein the user contact information comprises one or more of an email associated with a registered user of the mobile device or a phone number associated with the registered user of the mobile device.

16. The method of claim 10, further comprising booting into a normal operating state in response to a correct response to the key query such that the recovery mode is not executed.

17. The method of claim 10, further comprising:
receiving a recovery mode disable indication from a different device; and
disabling execution of the recovery mode.

18. A system comprising:
at least one memory; and
at least one processor coupled to the at least one memory and configured to cause the system to:
receive a notification of a full device reset of a mobile device;
transmit, in response to the notification of the full device reset, a key query to the mobile device requesting a recovery key for the mobile device; and
transmit a recovery mode instruction to the mobile device to execute a recovery mode in response to an incorrect response to the key query, the recovery mode instruction including instructions for the mobile device to:
obtain location data for a location of the mobile device; and
transmit the location data using user contact information stored on the mobile device.

19. The system of claim 18, wherein the recovery mode instruction further comprises an instruction to boot the mobile device into a normal operating state in response to a correct response to the key query such that the recovery mode is not executed.

20. The system of claim 18, wherein the at least one processor is configured to cause the system to receive, from the mobile device, one or more location notifications indicating a location of the mobile device.
